(19) United States
(12) Patent Application Publication
(10) Pub. No.: US 2015/0149461 A1
(43) Pub. Date: May 28, 2015

(54) System and method for analyzing unstructured data on applications, devices or networks

(71) Applicants: Luis Dario Aguilar Lemarroy, Seattle, WA (US); Marco Israel Muniz Esguerra, Querataro (MX)

(72) Inventors: Luis Dario Aguilar Lemarroy, Seattle, WA (US); Marco Israel Muniz Esguerra, Querataro (MX)

(73) Assignee: INTERSTACK, INC, Seattle, WA (US)

(21) Appl. No.: 14/088,414

(22) Filed: Nov. 24, 2013

(51) Int. Cl. G06F 17/30

(52) U.S. Cl. CPC G06F 17/30705
USPC 707/737

(57) ABSTRACT

A system, method, computer program and apparatus for facilitating the automated reading, decryption, retrieval, gathering, analyzing, indexing, segmentation, classification, grouping, comparing and storing of unstructured data from a set of one or more highly related computer programs, web applications or products which service a particular data transaction or system need.

### REFERENCES CITED

### Referenced by

U.S. Patent Documents

| | | |
|---|---|---|
| 6,061,675 | May 2000 | Wical |
| 6,105,046 | August 2000 | Greenfield et al. |
| 6,941,302 | September 2005 | Suchter |
| 6,961,692 | November 2005 | Polanyi et al. |
| 7,363,214 | April 2008 | Musgrove et al. |
| 7,603,268 | October 2009 | Volcani et al. |
| 7,796,937 | September 2010 | Burstein et al. |
| 8,024,173 | September 2011 | Kinder |
| 2007/0143236 | June 2007 | Huelsbergen et al. |
| 2008/0249764 | October 2008 | Huang et al. |
| 2009/0216524 | August 2009 | Skubacz et al. |
| 5,146,406 | September 1992 | Jensen |
| 5,418,717 | May 1995 | Su et al. |
| 5,943,670 | August 1999 | Prager |
| 6,278,987 | August 2001 | Reed et al. |
| 6,405,175 | June 2002 | Ng |
| 6,668,254 | December 2003 | Matson |
| 6,714,939 | March 2004 | Saldanha |
| 6,785,671 | August 2004 | Bailey |
| 6,986,104 | January 2006 | Green et al. |

### BACKGROUND OF THE INVENTION

1. Field of the Invention

The present invention generally relates to systems and methods for analyzing text, and more particularly to automated systems, methods and computer program products for facilitating the reading, analysis and scoring of words or sentences.

2. Related Art

In today's technological environment, many automated tools are known for analyzing text. Such tools include systems, methods and computer program products ranging from spell checkers to automated grammar checkers, translation tools and readability analyzers. That is, the ability to read and process text in an electronic form (e.g. in one or more proprietary word processing formats, ASCII, or an operating system's generic “plain text” format), parse the inputted text—determining the syntactic structure of a sentence or other string of symbols in some language, and then compare the parsed words to a database or other data repository (e.g., a dictionary) or set of rules (e.g., Latin grammar rules) that is known. This is true for text in different languages and regardless of whether that text is poetry or prose and, if prose, regardless of whether the prose is a novel, an essay, a textbook, a play, a movie script, a short manifesto, personal or official correspondence, a diary entry, a log entry, a blog entry, or a worded query, etc.

Some systems have gone further by attempting to develop artificial intelligence (AI) features to not only process text against databases, but to automate the “understanding” of the text itself. However, developing such natural language processing and natural language understanding systems has proven to be one of the most difficult problems, due to the complexity, irregularity and diversity of languages, as well as, the philosophical problems of meaning and the values associated with a meaning perception. More specifically, the difficulties arise from the following realities: text segmentation (e.g., recognizing the boundary between words or word groups in order to discern single concepts for processing); word sense disambiguation (e.g., many words have more than one meaning); syntactic ambiguity (e.g., grammar for natural languages is ambiguous, and a given sentence may be parsed in multiple ways based on context); and speech acts and plans (e.g., sentences often do not mean what they literally may imply).

Furthermore, in the past decades and especially in the last few years with the growth of data, network capabilities and new methods and ways to compute, data has been exponentially generated with multidimensional combinations of text, numbers and symbols creating a plethora of unstructured data.

This unstructured data which is composed of very fragmented text, numbers and symbols contains key data that represents valuable information that an analysis of this data can deliver valuable insight.

In view of the above-described difficulties, there is a need for systems, methods and computer programs for facilitating the automated analysis of unstructured data. For example, a healthcare provider delivers a large number of patients all sorts of different services, and in some occasions, delivering diagnosis and treatment recommendations. Additionally, this may occur over a multiple number of locations or internal groups, where different processes and methods are used to store and handle the data. Furthermore, there may be different types of systems, databases and applications where the data is being stored. Lastly, there is also a range of external data created where patients, for example, are sharing their experience via other communication methods with doctors or drug manufacturers for clinical studies purposes. The sheer volume of data (structured and unstructured) prevents healthcare providers, doctors, nurses and other administration personnel from physically being able to collect, aggregate and read some of the key records not to mention all the existing records to identify key trends or issues related to an specific treatment. Consequently, for example, key information that helps identify an improved method for a specific set of patients which may be successful, is not set in place or implemented.

Given the foregoing, what is needed is a system and method for analyzing unstructured data on applications, devices or networks. That is, for example, an automated solution tool to assist healthcare providers, doctors, nurses and other personnel to quickly “collect, process and analyze” the ongoing data being created on day to day operations of the healthcare provider.

The need to facilitate automated processing and reading of unstructured data goes beyond healthcare records and into a fragment set of multidimensional data and even in smaller blocks of numbers, text and symbols in standard formats, such as images' captions taken out of a variety of devices, text, numbers symbols and other elements or sequences taken of different sorts of documents, network, server and applications logs, database records and the internet.

To index and retrieve a meaning or values of units of text, several companies have devoted significant resources to creating keyword and phrase indices, with some semantic processing to group indexed text into semantically coherent ontological categories. However, usable meanings of text are not confined to dry ontological semantics. Indeed, often the most useful meaning of text is a matter of emotional mood, which greatly influences textual meanings. From a human cognitive standpoint, it is well understood that children initially develop a foundation of emotional memories, concerning needs and curiosity, from which ontological memories are later developed.

Therefore, there is a need for the automated processing of unstructured data to proceed from a foundation of identified references, in order to build a framework of retrievable meaning consistent with a human cognitive meaning specific for the use case. Building a framework of retrievable meaning or values upon emotionless ontologies deviates considerably from natural human values, so much so, that the resulting database is several interfaces removed from natural language and human thought; requiring multidimensional queries and interfaces to convert results into a meaningful set of identified patterns that delivers an actionable insight.

An automated collecting, processing and analyzing of unstructured data built upon a framework with the capabilities to identify a meaning or a value from multidimensional set or elements or artificially induce meaning based on some set of internal data or values that apply specifically for a specific scenario would be more efficient, as the key meaning of the data could be connected directly to an index of matching set of values and patterns of unstructured data.

### SUMMARY OF THE INVENTION

Aspects of the present invention are directed to system, method, computer program and apparatus for facilitating the automated reading, decryption, retrieval, gathering, analyzing, indexing, segmentation, classification, grouping, comparing and storing of unstructured data from a set of one or more highly related computer programs, web applications or products which service a particular data transaction or system need.

In one aspect of the present invention, an automated tool is provided to users, such as personnel of a Healthcare provider that allows such users to quickly analyze unstructured data. Such analysis may be used to assist in determining the potential success of a new method for patient care in near real-time. Such predicted success could be based upon the quality of the data input by the nurses, doctors or other employees in the systems. In other aspects of the present invention, quality and speed can be based on the technical capabilities of the systems in use, to store and process the data in a meaningful way. In other aspects of the present invention, quality is based upon metrics, values and scores involving such factors as character development, element recognition, gaps, climaxes and the like, all as described in more detail below. In some aspects, the scores may be standardized (e.g., converted to a score-system), for example, by subtracting the population mean from an individual raw score and then dividing the difference by the population standard deviation, as will be appreciated by those skilled in the statistical arts.

### BRIEF DESCRIPTION OF THE DRAWINGS

The features and advantages of aspects of the present invention will become more apparent from the detailed description set forth below when taken in conjunction with the drawings, in which like reference numbers indicate identical or functionally or similar elements.

FIG. 1 is a flowchart illustrating the simple process of an automated analyzing of unstructured data on applications, devices or networks according to one aspect of the present invention.

FIG. 2 is a table describing the simple steps of an automated analyzing of unstructured data on applications, devices or networks according to one aspect of the present invention.

FIGS. 3, 4 and 5 are exemplary screen shots generated by the graphical user interface according to aspects of the present invention.

FIG. 6 is a system diagram of an exemplary environment in which the present invention, in an aspect, could be implemented.

FIG. 7 is a block diagram of an exemplary internal computer system process useful for implementing aspects of the present invention.

FIGS. 8 and 9 shows exemplary dimensions of analysis for theoretical text and data segmentation, in accordance with aspects of the present invention.

### DETAILED DESCRIPTION

In the following description, for purposes of explanation, numerous specific details are set forth in order to provide a thorough understanding of some example embodiments. It may be evident, however, to the average user in the art, that embodiments of the invention may be practiced without these specific details.

In an example of text analysis, a system could include two main components: i) text extraction; and ii) text mining, wherein topic extraction includes a first phase to extract key phrases from texts and documents in the community forum, or other venue and a second phase of opinion mining to analyze the sentiment of sentences including the key phrases, and wherein the opinion mining includes syntactical analysis and lexical pattern matching. The topics may be ranked to identify essential topics. Automatic identification of essential topics in a given document corpus is a challenging task as words may be used in various contexts, and the corpus is a large set of texts or documents which are used to perform statistical analysis.

Additionally, a natural language process is used to identify key phrases related to the topic of interest among the various documents. Further, such processing may apply to a machine learning method to extract key phrases covered in the discussion posts and other documents. Once a group of essential ranking documents is identified, the methods applies a clustering technique to the group of documents, which infers a relationship(s) among topics that belong to that group.

All these former inventions have helped businesses process text in a faster way and at a more economically method. Still, there are multiple new areas that have created new challenges and areas of improvements where text analysis alone cannot be the solution.

Our invention goes beyond text analysis in multiple areas such as data gathering automation from multiple sources; building a multidimensional matrix and database of elements based on corpus; sorting, comparing, classification and replacing of elements; creating a scoring or metric system based on the identified elements specific to the corpus; and also the capabilities to identify patterns (sentiment being a possibility of pattern identification) based on the data processes; but most importantly the main difference is that unstructured data is more complex than text.

Unstructured data can be a sequence of letters, numbers or symbols (encrypted or not) that represent different meanings based on the corpus relevancy and specific line-of-business application. For example, a DNA sequence for a molecule is a succession of letters that indicate the order of nucleotides within a DNA (using GACT) or RNA (GACU) molecule. By convention, sequences are usually presented in a multiple combination of the letters A, U, G and C. Because nucleic acids are normally linear (unbranched) polymers. Specifying the sequence is equivalent to defining the covalent structure of the entire molecule. For this reason, a DNA sequence is an example of unstructured data. Other types of unstructured data may be binary codes, a variety of server or applications logs, encrypted communications sequences, for instance.

Text is a component of unstructured data and the capabilities to analyze text does not guarantee that you can analyze unstructured data. Furthermore, it is not adequate to analyze multidimensional corpus sets (even of text) where, for example, different variables apply, such as, a large variety of languages, and sentence building which must be considered in a multidimensional scoring matrix that is linked in a variety of relational commonalities that creates a network of meanings based on identified elements.

To move further into the description of the invention, aspects of the present invention will now be described in more detail here in terms of an exemplary evaluation of unstructured data, based on a Healthcare provider's operations. This is for convenience only and is not intended to limit the application of aspects of the present invention. In fact, after reading the following description, it will be apparent to one skilled in the relevant art(s) how to implement variations of the present invention, such as assisting doctors or nurses, who access the healthcare systems on a day to day basis for research and general understanding (e.g., for evaluating the progress of the applied care method to an specific patient).

The terms “user,” “patient”, “doctor”, “nurse,” “customer,” “participant,” “management” “reviewer,” and/or the plural form of these terms are used interchangeably throughout this disclosure to refer to those persons or entities capable of accessing, using, being affected by and/or benefiting from, the tool that aspects of the present invention provide for facilitating the automated analyzing of unstructured data on applications, devices or networks.

As will be appreciated by those skilled in the relevant art(s) after reading the description herein, in such an aspect, a service provider may allow access, on a free registration, paid subscriber and/or pay-per-use basis, to the tool via a World-Wide Web (WWW) site on the Internet, where the system is scalable in such that multiple doctors, nurses and other management personnel may login and utilize it to allow their users to submit patient information, review, screen, and generally manipulate various forms of text or data. At the same time, such a system could allow all users to browse for information or smaller units of data or text, such as specific symptoms or reported side-effects within the entered information, which may be offered freely.

As will also be appreciated by those skilled in the relevant art(s) after reading the description herein, alternate aspects of the present invention may include providing the tool for automated reading, analysis and scoring of unstructured data as a stand-alone system (e.g., installed on a single PC) or as an enterprise system wherein all the components of system are connected and communicate via an internal wide area network (WAN) or local area network (LAN). Furthermore, alternate aspects relate to providing the systems a Web service.

### The Data Gathering

For services offered through a networked communication system, such as an on-line service offered over the Internet, suppliers of drugs, doctors, nurses and other personnel coordinate with peers. Users of the system often provide comments and notes in regards to the current progress of a patient's health, which is then available to all respective participants and others. Often, the information relating to a specific method or drug applied under specific conditions to a pre-defined set of patients is entered in the notes, report or progress sections on the solution, and includes significant valuable information related to frequency, levels and sentiment metrics and polarity. Some key comments related to a specific topic may be entered as a key differentiator in multiple patients' progress reports or sections. For example, comments relating to a group of the patients on a pre-categorized segment that apply only to an older group may be entered in a different forum, specifically tailored for the older group traction. When seeking information related to the specific group of older patients, a user of the solution may be presented with a multitude of reports, drug dosage metrics, notes and so forth, requiring the solution user to manually scan through all the key data and read the individual notes and numeric metrics to build a sense of understanding on the patients status progress. This may become burdensome with the levels of available data.

Doctors, nurses and other personnel required to continuously monitor the progress and new relevant changes and opinions, as to progress. Drug manufacturers and others also seek this information. In practice, many of these reports receive a great volume of entries, making identification of desired information difficult, as a search of these entries requires the user to manually read through all reports and notes.

The following description details a system, method, computer program and apparatus for facilitating the automated reading, decryption, retrieval, gathering, analyzing, indexing, segmentation, classification, grouping, comparing and storing of unstructured data from a set of one or more highly related computer programs, web applications or products which service a particular data transaction or system need. The processes discussed herein help collect and gather the data to identify key information automatically, avoiding manual gathering of the data and searching of these patterns.

### The Extraction and Mapping Process

In one embodiment, automatic key phrase extraction provides a tool for identifying words and phrases used in reports, entries, emails, and other documents related to a topic. Phrases are linguistic descriptors of textual content of documents and phrase extraction is implemented to retrieve phrases from documents. In some embodiments, the method includes a natural language processing tool to find noun phrases and verb phrases automatically. In many text-related applications techniques for clustering and summarization also may be used to identify phrases indicating a sentiment as explained before. A data mining or machine learning tool may be used to find multi-word phrases or other parts of a text. An extraction process may include two stages, a first stage which builds a model based on training from a set of documents and a second stage uses that model to predict the likelihood of each phrase or word in the new given set of documents. The first stage may include manually authored key phrases, such as those submitted by a user looking for specific words or phrases. In one example, the system enables selection of a multi-word concept, such as “over doses.”

The target of topic extraction is a set of documents or raw business data within a given set of a corpus. A document as used herein refers to information in a textual form, such as comments submitted to a community forum. Service providers may provide a forum or board which allows postings of comments, feedback, questions and other information. A topic is a concept, expressed either in single words or multi-word phrases, representing a concept or idea for a set of documents. In some examples, the topic may represent ideas substantially related to the documents, such as to the content of the documents, type of documents, or title of documents. The system identifies information related to a specific topic, and from this information determines opinions and other values related to the topic. The topic may be broadly defined, and may include multiple subtopics. The topics may be computed and selected using a combination of multiple methods, like Term Frequency, Document Frequency, Mutual Information, Latent Allocation and others. The topics identified are then stored in a database table for further use.

As described, a variety of documents can be provided as inputs for the topic extractor, which includes an index module a topic extraction module and optional additional filters. The index module is used to index and organize the various documents and sets of unstructured data within a corpus. The process puts the documents in an order to facilitate searching and analysis. The index module records and indexes the number of each post or data for reference and retrieval. The index module outputs an index that contains map of the corpus. Mapping each elements to all constituent, words, sequences, IDs, tokens and any other value.

### Building the Database and Multidimensional Matrix

According to some embodiments, sequences and other multiple elements generated from various methods are ranked as a function of weights applied by at least one process. The rankings are evaluated with respect to a threshold or metric, those elements having ranks that exceed the threshold are considered essential at operation. The base methods may be used to generate key sequences and use this as input to improve the grouping result. The list of essential topics is created or further extended to identify associated subtopics.

Once the list of topics and subtopics are identified, the process associates the obtained unstructured data with corresponding topics at operation. For a given topic, those sets of corpuses in which the topic (e.g., essential a key sequence) appears are grouped together.

Various methods, based on the specific lie-of-business application, can be used to extend a corpus grouping, e.g., those sequences and/or elements to which the topic is highly related can also be grouped. Moreover, different relationships may be extracted among topics that belong to a different group. In a second stage, the method then can use a model to predict the likelihood of each sequence in a new given corpus. Some examples use a method first to extract important sequences, and then use another method incorporating the results to improve the topics list by selecting repetitive pool of candidate elements for grouping at the very beginning.

Sub sequentially the corpus(es) can be then associated with the topic(s) based on the essential key denominator found in the corpuses at operation and grouped at operation based on occurrence, frequency and use of key sequences found in the corpus. The retrieved and grouped corpus containing the essential keywords are provided as relevant building a matrix.

In some cases or scenarios, some embodiments also use other filtering techniques to identify and evaluate key sequences, including the use of heuristics in key element extraction, such as case-sensitiveness, identification of known stop tokens, which are filtered out prior due to their common identified meaning and other criteria based on mutual information, and length or number of characters in a sequence. The mutual information can be a quantity that measures the mutual dependence of multiple variables.

Furthermore, a syntax processor further builds a syntactic tree for each sequence of the relevant corpus that includes an essential key sequence at operation. A syntactic tree is a tree that represents the syntactic structure of a string according to a set of rules. (e.g. for text would be grammatical rules or norms). An example of such a tree includes multiple nodes identified as source nodes, leaf nodes or internal nodes, and terminal nodes. A parent node has a branch underneath the node, while a child node has at least one branch directly above the node. The relationships are thus defined by branches connecting the nodes. The tree structure should show the relationships among the various parts of a sequence.

As an example, building a syntax tree, may incorporate a natural language parsing tool to obtain a syntactic tree of a target language sentence. The parsing may include detection of subjects and objects within the sentence, which information is used to better understand the use of words, terms, phrases and grammatical parts of the sentence structure. Additionally, parsing may involve detection of negation words, such as “nor,” “not,” and “no.” For example, the negation words may include “no trust,” “not trusted,” and “nor trusted.” The parsing may also include pronoun cross-reference, and other information as to sentence structure. Similar approach and methods are used to build a syntactic tree for unstructured data that is based on rules that apply specifically to the corpus.

The parsing can also allow the syntax processor to build a treat or polarity operation and execute assignments of polarity or treatment that impact individual tokens, elements or sequences at operation. For each of the polarity key elements included in the sequence, the impact assignment could be interpreted as a score identifying the impact of each polarity key sequence. The polarity assignment may be a factor which indicates how much impact the sequence has on the given topic.

As an example, consider the following scenario: In the notes report of our tool we could find the following comments: “Patient showed dramatic signs of sides-effects with the new dosage of 5 mml, decided to go back to old dosage where, even at a slower pace, better results were achieved.” In this text, the there are two polarity words, “dramatic” and “better” These two polarity words are in conflict as the first word has a negative meaning while the second word has a positive meaning. In this example, the word “dramatic” is a stronger word and has more impact on the given topic. The stronger impact may also reflect a direct relation with the topic.” Therefore, under a text analysis perspective only the entire text is to be tagged as negative based on a comparison of the impact of the conflicting terms.

Under an unstructured data analysis perspective, based on the same example, our method will have multidimensional polarities identified in a matrix. The sequence “5 mml” in the phrase will have a stronger impact and relevancy, since identifies it as a pattern on the given results. Delivering to the users of the solution a complete new key insight on the overall analysis.

Therefore, building a multidimensional matrix, based on the polarity impact assignment needs to be determined using a variety of methods and ways to further add new dimensions of impact based on the cumulative value of the elements and sequences, and linking the impact to other identifying elements, that may not just be text, but also for example time, and other numeric values that may not be identify as relevant, only after a series of methods that all linked together represent a new insight under a matrix.

There are multiple ways to measure polarity and its impact. In one way, the polarity impact could consider the polarity word having a dominant impact on the topic, and then use that word to determine the sentiment orientation of the topic. In another method, the polarity impact could be determined by a sum of polarities. Using the sum of polarities method, the example text will be tagged as neutral. Positive words are assigned a +1 value and negative words are assigned a −1 value. The sum of the polarities method adds up the polarities of the words in a sentence. For each pair in a sentence, where w.sub.i is a word and p.sub.i the corresponding polarity. The sum is therefore the sum of all pi in the sentence. Additionally the impact score may also be detected using the syntactic distance between the word and the topic in the syntactic tree. In other words, the number of branches from a polarity word back up to the topic key phrase determines the impact of the polarity word.

Based on the explanations mentioned above, we build a scoring system based on a multiple set of methods to have the capabilities to build a matrix based on identifying key element links and relations to the corpuses. At the decision point, the analyzer determines if there are any conflicting polarity elements, and if so, compares the polarity impact at operation to build a polarity classification, which may be positive, negative or neutral with additional embodiments of classifications indicating a multidimensional degree of polarity.

At operation, heuristic rules may apply to classified polarity elements and text. For example, in parts of a text found on our unstructured data, these rules may handle special situations and usage patterns in text, such as negation, enantiosis and questioning. Negation words are those that tend to be related to negative sentiment, such as “nobody,” “null,” “never,” “neither,” “nor,” “rarely,” “seldom,” “hardly,” and “without,” in addition to the words given above. Following a negation word, if the polarity word is close to the negation word and there is no punctuation that separates the polarity word and the negation word, then the significance of the polarity word is reversed. Additionally, the heuristic rules may evaluate figures of speech, such as enantiosis, which affirmatively states a negation, or vice versa. In some examples, question sentences may be skipped, as the meaning is ambiguous. The heuristics for the topic extractor are used to identify lexical units or phrases. These heuristics are used for sentiment analysis and may be expressed using a common format or language, such as rules and patterns, and overall delivers only one dimension and component on our method.

### Scoring and Processing

Continuing with the process, the unstructured data from the relevant corpus is then processed by the analyzer to evaluate the elements and sequences that contain metrics and value indicators which allows the elements and sequences be classified in a multidimensional levels of values. The resultant classification is used to understand and provide scoring about the topic of the corpus. To this end, as described before, a polarity dictionary may be used to identify specific polarity values to elements like words. The analyzer includes a polarity detection unit, used with the polarity dictionary to identify key elements which indicate a value on a metric scale. In one example, the polarity identifies positive or negative comments. However, in some embodiments, other sentiments may be identified as well, such as informational set of values only meaningful to the specific scenario.

In the process, a parser receives the polarity information from the polarity detection unit and applies a parsing operation to the received information. The parser can or may be used to build a tree of a sequence or portion of text, and may apply heuristic rules to identify or filter particular portions of the sequence or portion of text as mentioned before. The parser receives the data that must be analyzed as a set of sequences or strings.

This process mainly includes element tokenization, tagging and relation recognition of components, sequences or elements. The results from the parser can be applied to a lexical or sequential matcher. The analyzer and modules therein, may access information stored in the matrix relating to the topic, such as a values, scores and metrics of topics and opinions. The detection modules further use information from the built dictionary, which may include terms, elements, sequences and other components organized and grouped according to relationships of synonyms and so forth. A possible result could be the sentiment on an expression based on a combination between polarity words and elements relations.

Additionally, in application, a wildcard may be implemented, such as to use “*” as a component or element replacement. For example, a token that includes a wildcard in a specific field, but identifies a positive polarity in a polarity metric and this token applies to any suitable positive element, meaning this is one of the special words based on relation.

Furthermore, embodiments may include a variety of elements to identify the parts of a sequence broadly, using fewer elements, or narrowly, using more elements.

Additionally, an example sequence having a set of tokens and includes a special token and wildcards, where the token can be used to identify any sequence containing the topic or key sequence of any polarity and used as part of the sequence can be used as an element or component to identify patterns.

In one embodiment, a pattern is a list of pre-defined tokens and serves as a rule for determining the value of a sequence. Each token can be an individual element, component or even words or phrases. For each given sequence, the analyzer builds a metric system. If all the elements in a rule may be matched by a token then the rule may be applied to the target sequence and identify a pattern.

### Identifying Patterns

In one embodiment, a text analyzing method is determined by the corpus of data that needs to be analyzed and also the goals and metrics looked after. Multiple methods can be used or apply to find different set of results. In the following there is a description of some (not all) of the methods that can be used to identify patterns and help describe how all this methods or some are used to analyze data and identify patterns.

Searching the universe of natural language text by grammar or by ontological standards pre-supposes an orderliness to natural language that generally does not and will not exist. Consequently, the method generates a rhetorical ontology more generally useful to people, bypassing the extraneous results returned by grammar or standardized ontology, and allowing people to find text via rhetorical metaphors which cannot be standardized.

The output of Results can be displayed to a user on a computer system interface, so that the user can re-query as needed, as with traditional search engines. The results may be displayed as an ontology or as a sorted list of results.

Often, a large body of text must be processed into classifications. For instance, customer service emails must be classified into groups for tracking customer satisfaction and to relay emails to specialized staff areas. For the benefit of the legal community, in the field of citation tracking within court cases, citations need to be sorted into citations, which affirm cited court decisions and citations, which have issues or problems with court decisions. In this way, lawyers are informed as to which court decisions are considered non-controversial good law overall and which decisions are problematic, controversial law. To address these and similar needs to classify text on a large scale a Natural Language processor can be used.

Querying for an ontology query array has the additional advantage of returning multiple result sets, one for each query ontology. Each result set can then populate a category, perhaps further qualified by workflow dates or workflow locations to automatically supply relevant results to specialized staff areas or to update court decisions databases. Beyond simple categorization, ontology query arrays may be used for conversational computing interfaces, where possible conversational focuses are each represented by a query ontology, and the conversation is steered in the direction of whichever Result has the highest relevance returned.

Disambiguation can also be used, whether for automating natural language translation or simply clarifying the meaning of text, the average polysemy of a word links to an average of three distinct meanings in a traditional semantic ontology such as WordNet. In an automatically generated ontology, the polysemy of a word can have a variety of different meanings. For automatically generated ontologies, the greater polysemy makes the need for disambiguation more significant.

By mapping the rhetorical relationships between key-elements, multiple methods automatically generate a hierarchy of linked key-elements. As with any linked hierarchy of terms, the relationships expressed by that hierarchy can be traversed to compute a relative distance or mutual relevance or disambiguation distance between terms.

Those skilled in the art of traversing ontologies will recognize that the present invention may include many variations in computing distances, adjusting for clustering and classification features, using techniques from topology, statistics and computational linguistics

The present invention includes other variations in computing distance from its rich emotion detection capabilities to sharpening the precision of natural language disambiguation using rhetorical distance functions.

Additionally, the present invention refers to methods of applying “best fit” calculations to candidate ontology sub-trees as a Shortest Rhetorical Distance Function, which produces a Rhetorically Compact Disambiguation.

Those skilled in the art of natural language disambiguation will recognize that a “best fit” technique can also be easily applied to fitting topological aspects of an exemplary ontology to sub-trees connected to candidate node results from a Dictionary or Polysemy Index, as described by Natural Language Disambiguation Methods.

In other aspects of the present invention, further improvements in the accuracy of detection of emotions in text can be made by performing an analysis of sentiment or emotion based in part upon a measure of contextual sentiment and a contextual emotion similarity between rhetorically or ontologically similar texts.

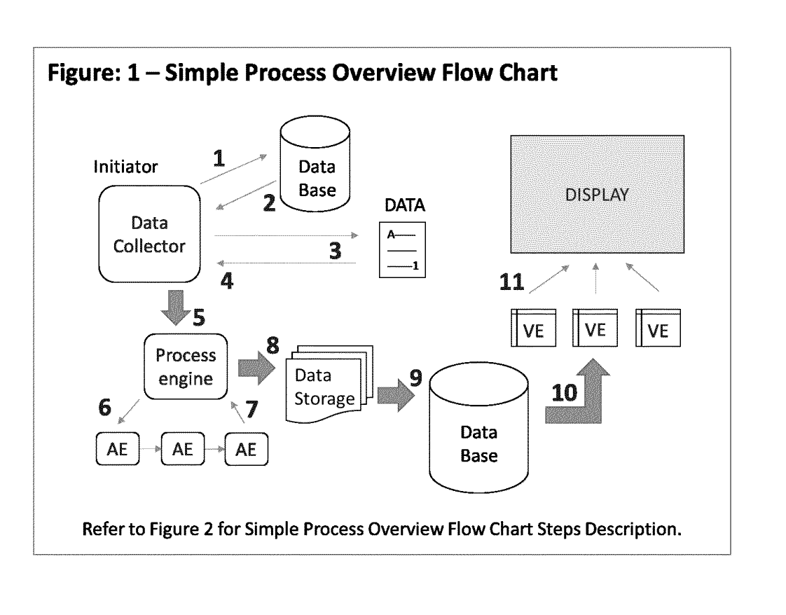

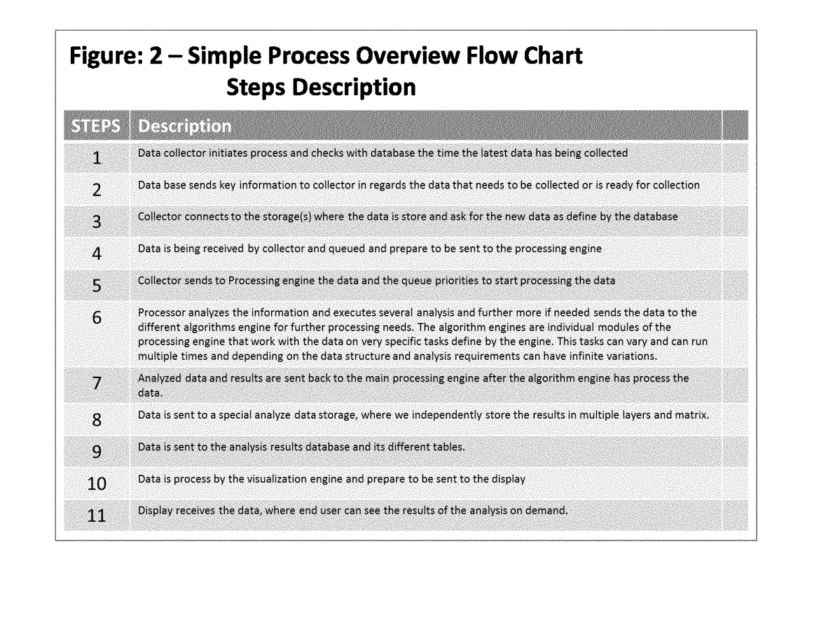

Referring to our invention in FIG. 1, we show a flowchart illustrating an automated reading, analysis and scoring unstructured data process, according to one aspect of the present invention. The process begins at step 5 where stored data streams (text notes and numeric databases information) to be analyzed are taken as the input of the process. The text stream and database information, in one illustrative example in accordance with an aspect of the present invention, where both streams are being analyzed. As will be appreciated by those skilled in the relevant art(s), that the data streams may be in electronic form (e.g., in one or more proprietary processing formats, ASCII or in an operating system's generic “plain text” format).

As will be appreciated by those skilled in the relevant art(s) after reading the description herein, the lexicography of aspects of the present invention mirrors, by analogy that of the life sciences. That is, the method starts with individual tokens (e.g., chromosomes), groups the tokens to derive the “genes” of the text under analysis, and groups the “genes” to derive the literary “DNA” of the analyzed text.

In an aspect of the present invention, value levels are summary attributes of each concept pair, such as the idea of respect. These summary aspects are used to summarize overall metrical characteristics of units of unstructured data, so that a sequence or elements, for example, may be characterized by its overall polarity, by summing the different values of its constituent tokens of the sequences or elements. The resulting Levels are used to characterize overall metrical levels of unstructured data. In some variations of the present invention, Levels are used to determine which levels of values are addressed by a section of data, and whether or not any levels are missing.

In accordance with other aspects of the present invention, dimensions of results may be extended beyond the sum of values to encompass artificial intelligence inherent to the gene-num pair concepts. Many other such dimensions could be mapped; however, it has been found by experimentation that multiple dimensions can be used to a mapping table and can be extended into additional dimensions, while retaining at least one common denominator as the base level and values characteristics. In accordance with aspects of the present invention, the tables could be similarly reconfigured to have additional dimensions. It is key to mention that accuracy does not necessarily improve with additional dimensions. In actuality, we have identified that dimensions closer to the first defined matrix tree, can be more relevant to the progressions than simple displacements between polarity. Nevertheless, the relative simplicity of building analysis and display tools for a simple polarity resolution system often favors its use, particularly among casual users. Aspects of the trade-off between accuracy and usability can be identified in more detail below, after more of the elements and methods have been introduced. It has been found experimentally that parsing data based on 5 element groupings can be sufficiently accurate for about 89% of corpuses analyzed. Furthermore, of the approximately 11% of groupings data which appear mismatched to pair concepts, approximately 90% have been found to be well matched within the same sequence, indicating that underlying meanings or values of elements combinations eventually converge to the final mappings. Consequently, the approximately 10% mismatch can be viewed as a kind of digression within the data, and it has been experientially found that such digressions generally weaken the results, making the analysis less vibrant and more obscure.

After involving the various factors discussed above, it is also worth mentioning that a gap analysis is yet another method in accordance with aspects of the present invention that may be used to compute overall data metrics and data quality.

For example, data stream annotated for Gaps can produce an operation that is fed to the accumulator operation to produce a Total Gap Tally, which can then be used as a part measure of data quality.

Aspects of the present invention may utilize other perspectives to make further adjustments to the metrics calculated and to take advantage of the stability consistency in the significance of absolute levels of those metrics. For instance, areas exceeding a specific threshold of polarity impact can be assigned extra credit as a Peak, and polarity Peaks can be assign even greater credit or value.

Additionally, other Methods can provide a useful foundation of data segmentation for mapping higher levels of values. Whether by mapping boundaries of fluctuations or over multiple dimensions, simultaneously mapping the boundaries associated with changes, with the goal to use vector sums of boundaries for grouping rhetorically significant to related regions of data. Rhetoric involves traversing values on both polarities sides.

As an example, our invention methods could be used to detect emotions or sentiments of sentences as used in texts, having similar ontological meanings. While the above is a very simple method for detecting sentiments it is key to mention that our invention, even though it has being designed to execute more difficult analysis, can be used to execute simple analysis and recognize simple patterns as well.

Overall the capabilities needed to be able to identify Patterns via analysis on unstructured data, is highly dependent on the corpus structure or architecture. In some cases a feature reach set of algorithms needs to be employed, using a combination of some of the methods mentioned above. In some cases a simpler algorithm can be used to identify the patterns.

### The System

It is important to explain that our invention possesses other features and capabilities implied, but not in detail described here. The following explanations are a general description of what our invention system may contain, but is not limited to.

Our system has a mechanism to present the information in a format for users to evaluate and may be implemented into, a decision making process. In one example, the resultant information is presented graphically to identify trends. The information may further be used to generate ratios of positive feedback to negative feedback. In some examples, the information is automatically evaluated and presented to a requester as an alarm or indicator when the resultant information satisfies specified criteria. In other examples, the resultant information is compared to information related to other queries, such as to compare results for one product against results for a similar or competing product.

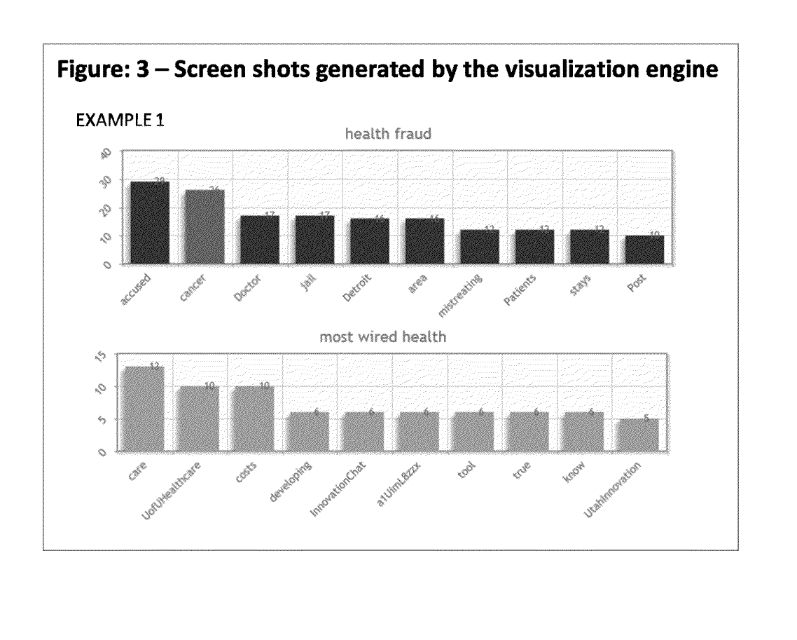

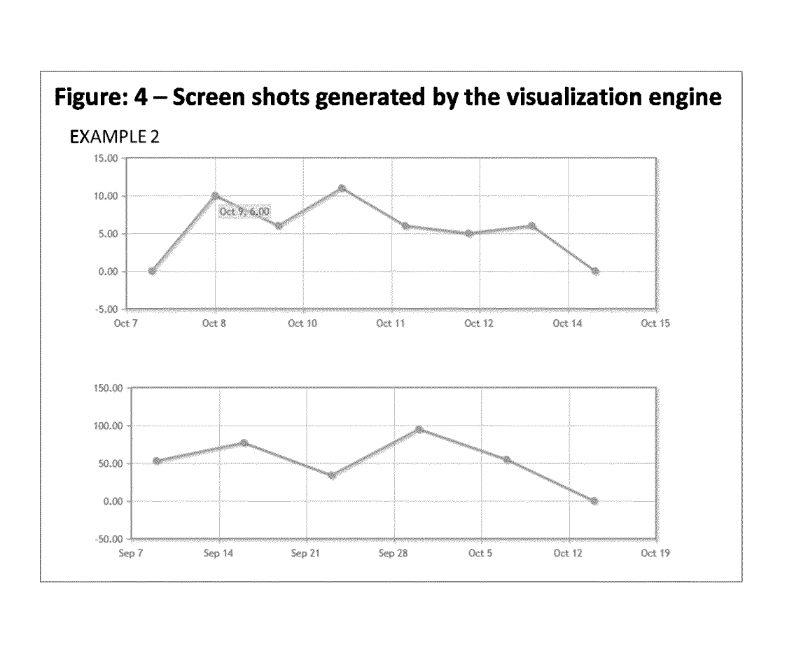

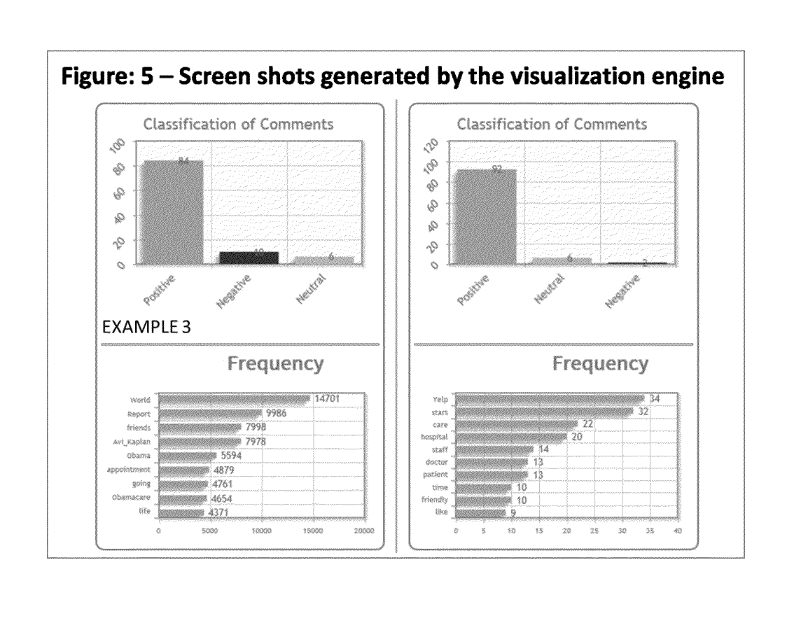

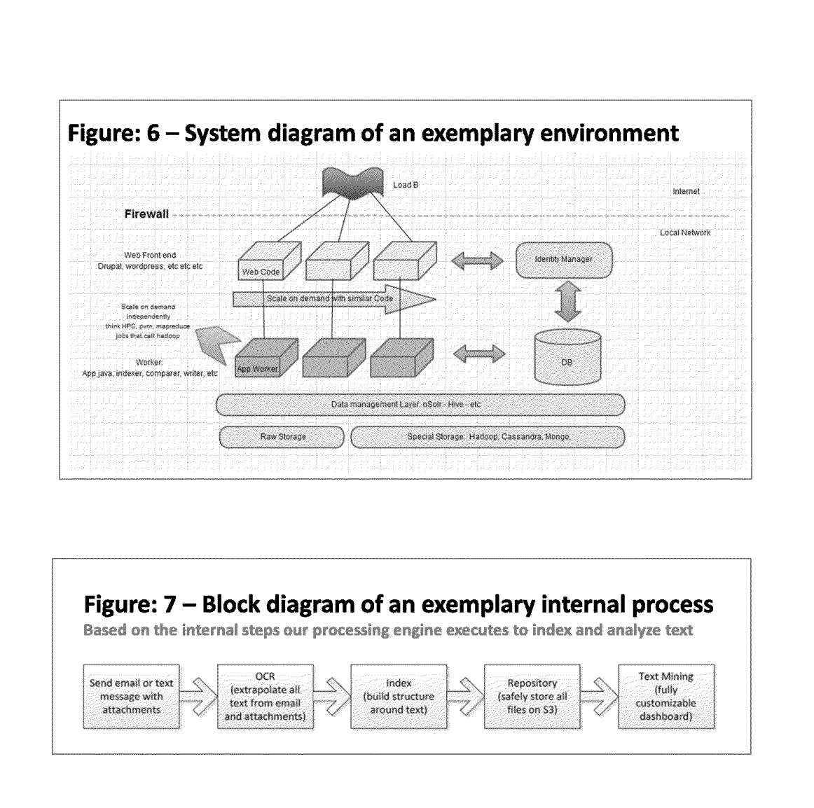

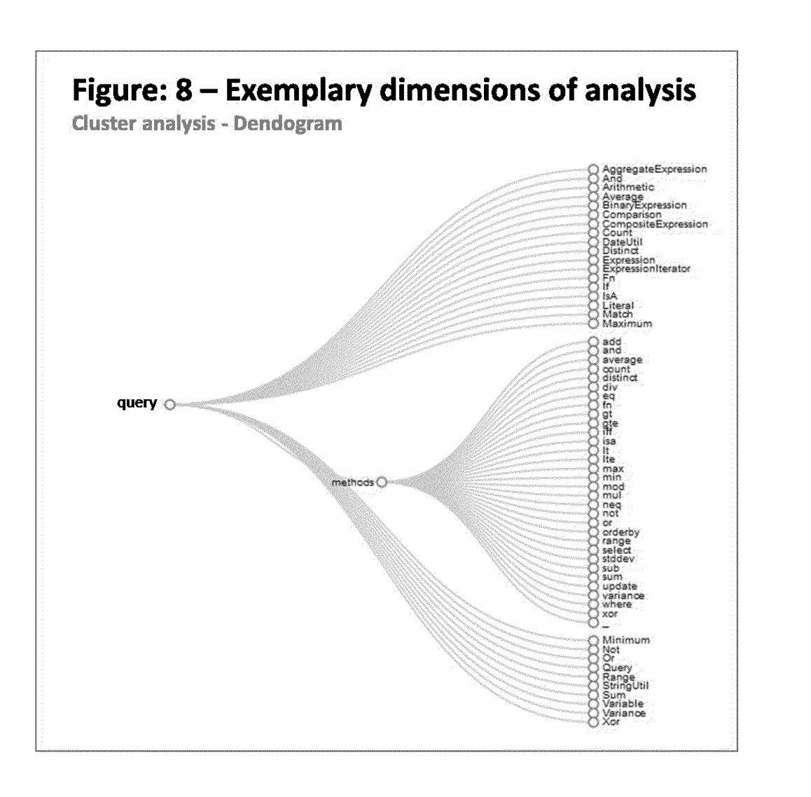

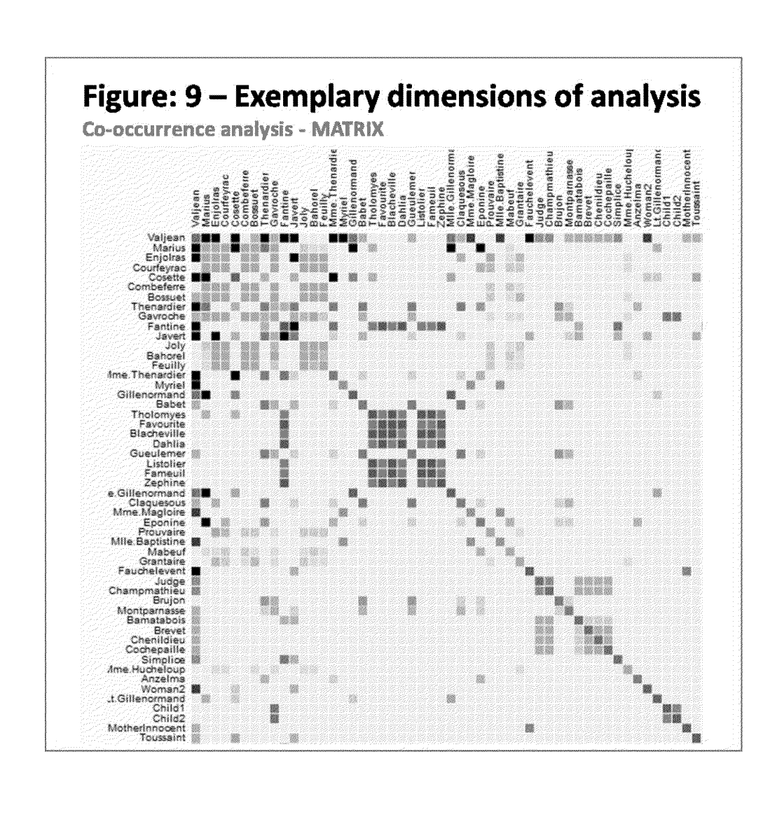

Referring to FIGS. 3, 4 and 5, these figures show exemplary windows or screen shots generated by an exemplary graphical user interface (GUI), in accordance with aspects of the present invention. Some variations of exemplary screen shots may be generated by a server in response to input from user over a network, such as the Internet.

Our system for implementing unstructured data analysis can include a communication bus, coupling the various units within the system. A central processing unit controls operations within the system and is responsive to execute computer-readable instructions for operations within the system. An element extraction unit coupled to the interfaces, which may include an Application Programming Interface (API). The extraction unit can receive information and control information from a user via the interface. In some embodiments the interfaces can be coupled directly to the extraction or detection. The extractor unit can receive information from databases and memory storage via the communication bus. The databases can include polarity dictionaries having listings for a variety of elements or sentences that are associated with polarity. The system can perform the operations described with respect to the various methods and apparatuses described herein.

The system can include a receiver and a transmitter to facilitate wireless communications. Some embodiments have no wireless capability.

The system can also contain a specific graphical user interface for reporting the extraction and may visualize the analysis, wherein the unstructured data is listed in total or as a portion, and a graph of the polarity analysis can also be shown. This information may be used to identify positive or negative trends associated with patient improvements, release of features, upgrades, applications, services and so forth. The methods described above may be used to extract and analyze data for generation of trends.

The functions of the various modules and components of our system may be implemented in software, firmware, hardware, an Application Specific Integrated Circuit (ASIC) or combination thereof. A specific machine may be implemented in the form of a computer system, within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a cellular telephone, a web appliance, a network router, switch or bridge, or any machine capable of executing instructions (sequential or otherwise) that specify actions to be taken by that machine. Further, while only a single machine may be mentioned or illustrated, the term “machine” shall also be taken to include any collection of machines that individually or jointly execute a set (or multiple sets) of instructions to perform any one or more of the methodologies discussed herein.

An example computer system, can include a processor, such as a central processing unit, which includes or executes instructions for operations and functions performed within and by the computer system. Furthermore, the memory storage may include instructions for storage in and control of memory storage. A static memory or other memories may also be provided. Similarly, a memory storage may be partitioned to accommodate the various functions and operations within the system.

The system may further include a video display unit (e.g., a Liquid Crystal Display (LCD) or a Cathode Ray Tube (CRT)). The system may also include an input device to access and receive computer-readable instructions from a medium having instructions for storing and controlling the computer-readable medium.

Certain embodiments are described herein as including logic or a number of components, modules, or mechanisms. A component may be any tangible unit capable of performing certain operations and may be configured or arranged in a certain manner.

In various embodiments, a component may be implemented mechanically or electronically. For example, a component may comprise dedicated circuitry or logic permanently configured (e.g., as a special-purpose processor) to perform certain operations. A component may also comprise programmable logic or circuitry (e.g., as encompassed within a general-purpose processor or other programmable processor) temporarily configured by software to perform certain operations. It may be appreciated that the decision to implement a component mechanically, in dedicated and permanently configured circuitry, or in temporarily configured circuitry (e.g., configured by software) may be driven by cost and time considerations.

Accordingly, the term “component” may be understood to encompass a tangible entity, be that an entity physically constructed, permanently configured (e.g., hardwired) or temporarily configured (e.g., programmed) to operate in a certain manner and/or to perform certain operations described herein. Considering embodiments in which components are temporarily configured (e.g., programmed), each of the components need not be configured or instantiated at any one instance in time. For example, where the components comprise a general-purpose processor configured using software, the general-purpose processor may be configured as respective different components at different times. Software may accordingly configure a processor, for example, to constitute a particular component at one instance of time and to constitute a different component at a different instance of time.

Components can provide information to, and receive information from, other components. Accordingly, the described components may be regarded as being communicatively coupled. Where multiples of such components exist contemporaneously, communications may be achieved through signal transmission (e.g., over appropriate circuits and buses) that connect the components. The embodiments in which multiple components are configured or instantiated at different times, communications between such components may be achieved, for example, through the storage and retrieval of information in memory structures to which the multiple components have access. For example, one component may perform an operation and store the output of that operation in a memory device to which it is communicatively coupled. A further component may, at a later time, access the memory device to retrieve and process the stored output. Components may also initiate communications with input or output devices, and can operate on a resource (e.g., a collection of information).

Example embodiments may be implemented in digital electronic circuitry, or in computer hardware, firmware, software, or in combinations of these. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network. In example embodiments, operations may be performed by one or more programmable processors executing a computer program to perform functions by operating on input data and generating output. Method operations can also be performed by, and apparatus of example embodiments may be implemented as, special purpose logic circuitry, e.g., as a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers having a client-server relationship to each other. In embodiments deploying a programmable computing system, it may be appreciated that both hardware and software architectures require consideration. Specifically, it may be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

While a machine-readable medium can be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium capable of storing, encoding or carrying instructions for execution by the machine and that cause the machine to perform any one or more of the methodologies presented herein or capable of storing, encoding or carrying data structures utilized by or associated with such instructions. The term “machine-readable medium” shall accordingly be taken to include, but not be limited to, tangible media, such as solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The system instructions used within a computer system may further be transmitted or received over a communications network using a transmission medium. The instructions, and other information, may be transmitted using the network interface device 920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible medium to facilitate communication of such software.

In some embodiments, the described methods may be implemented using one of a distributed or non-distributed software application designed under a three-tier architecture paradigm. Under this paradigm, various parts of computer code (or software) that instantiate or configure components or modules may be categorized as belonging to one or more of these three tiers. Some embodiments may include a first tier as an interface (e.g., an interface tier). Further, a second tier may be a logic (or application) tier that performs application processing of data inputted through the interface level. The logic tier may communicate the results of such processing to the interface tier, and/or to a backend, or storage tier. The processing performed by the logic tier may relate to certain rules or processes that govern the software as a whole. A third, storage tier, may be a persistent storage medium, or a non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. The three-tier architecture may be implemented using one technology or a variety of technologies. The example three-tier architecture, and the technologies through which it is implemented, may be realized on one or more computer systems operating, for example, as a standalone system, or organized in a server-client, peer-to-peer, distributed, or some other suitable configuration. Further, these three tiers may be distributed between more than one computer systems as various components.

Example embodiments may include the above described tiers, and processes or operations about constituting these tiers may be implemented as components. Common to many of these components is the ability to generate, use, and manipulate data. The components, and the functionality associated with each, may form part of standalone, client, server, or peer computer systems. The various components may be implemented by a computer system on an as-needed basis. These components may include software written in an array of multiple computer language such that a programming technique can be implemented or other suitable technique.

Software for these components may further enable communicative coupling to other components (e.g., via various Application Programming interfaces (APIs)), and may be compiled into one complete server, client, and/or peer software application. Further, these APIs may be able to communicate through various distributed programming protocols as distributed computing components.

Some example embodiments may include remote procedure calls being used to implement one or more of the above described components across a distributed programming environment as distributed computing components. For example, an interface component (e.g., an interface tier) may form part of a first computer system remotely located from a second computer system containing a logic component (e.g., a logic tier). These first and second computer systems may be configured in a standalone, server-client, peer-to-peer, or some other suitable configuration. Software for the components may be written using the above described object-oriented programming techniques, and can be written in the same programming language, or a different programming language. Various protocols may be implemented to enable these various components to communicate regardless of the programming language used to write these components.

Example embodiments may use the OSI model or TCP/IP protocol stack model for defining the protocols used by a network to transmit data. In applying these models, a system of data transmission between a server and client, or between peer computer systems, may, for example, include five layers comprising: an application layer, a transport layer, a network layer, a data link layer, and a physical layer. In the case of software for instantiating or configuring components having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), Wide Area Network (WAN), or some other suitable network. In some cases, internet refers to a network of networks. These networks may use a variety of protocols for the exchange of data, including the aforementioned TCP/IP, and additionally Asynchronous Transfer Mode (ATM), Synchronous Network Architecture (SNA), Serial Data Interface (SDI), or some other suitable protocol. These networks may be organized within a variety of topologies (e.g., a star topology), or structures.

Although an embodiment has been described with reference to specific example embodiments, it may be evident that various modifications and changes may be made to these embodiments without departing from the broader spirit and scope of the present discussion. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Aspects of the present invention or any part(s) or function(s) thereof may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein that form part of the present invention. Rather, the operations are machine operations. Useful machines for performing the operation of the present invention include general purpose digital computers or similar devices.

Various software aspects are described in terms of this exemplary computer system. After reading this description, it will become apparent to a person skilled in the relevant art(s) how to implement aspects of the present invention using other computer systems and/or architectures.

In another variation, aspects of the present invention are implemented primarily in hardware using, for example, hardware components such as application specific integrated circuits (ASICs). Implementation of the hardware state machine so as to perform the functions described herein will be apparent to persons skilled in the relevant art(s).

In yet another variation, aspects of the present invention are implemented using a combination of both hardware and software.

### CONCLUSION

While various aspects of the present invention have been described above, it should be understood that they have been presented by way of example, and not limitation. It will be apparent to persons skilled in the relevant art(s) that various changes in form and detail can be made therein without departing from the spirit and scope illustrated herein. Thus, aspects of the present invention should not be limited by any of the above described exemplary aspects.

In addition, it should be understood that the figures and screen shots illustrated in the attachments, which highlight the functionality and advantages in accordance with aspects of the present invention, are presented for example purposes only. The architecture illustrated herein is sufficiently flexible and configurable, such that it may be utilized (and navigated) in ways other than that shown in the accompanying figures.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it may be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, may be apparent to those of ordinary skill in the art upon reviewing the above description.

| | | |
|---|---|---|
| 7,020,662 | March 2006 | Boreham et al. |
| 7,043,420 | May 2006 | Ratnaparkhi |

What we are claiming:

1. A computational, implemented method for automatically creating an analysis of unstructured data comprising a multidimensional set of corpus and sequences of alphanumeric verbatim or words, the device comprising one or more processors and a user interface, the method comprising: gathering and capturing the unstructured data; performing, via the processors, element by element analysis by reading, mapping, grouping, tagging and comparing elements of the unstructured data, based on specific mappings of define corpus structures and patterns; performing, via the device processor(s), an analysis of the unstructured data using a multiple set of predefined algorithms, related to the corpus architectural analysis and structure; and outputting, via an interface, the computational analysis of the unstructured data; wherein the computational analysis can include a classification, a segmentation, a regression, a categorization and/or a comparing multiple corpus sets of unstructured data to one or multiple elements structures or patterns to similarity.

2. The implemented method according to claim 1, further comprising: processing at least one corpus to determine patterns or sequences in the corpus; associating a respective tag with each verbatim, each respective tag indicating a part of a pattern; and using at least one of the identified tags to determine the unstructured data architectural metrics and values.

3. The implemented method according to claim 1, further comprising: identifying one or more alphanumeric values in at least a set of corpus; and replacing each of the one or more identified values with an element.

4. The implemented method according to claim 1, further comprising: using pre-selected attribute value or values to identify one or more additional attribute-pairs and values in at least one corpus.

5. The implemented method according to claim 1, where, when mining the plurality of attributes and the plurality of values, the method includes: using one or multiple tokens to exclude at least one sequence from extraction.

6. An apparatus comprising: memory, instructions; and a processor to execute the commands to: mined, from at least one set of corpuses, a plurality of attributes and a plurality of values; identify, from the mined plurality of attributes and the mined plurality of values, a multidimensional attribute-value pairs; determine results metrics for every attribute-value pairs, the processor, when determining the results metrics for every attribute-value pairs being to: determine, for every attribute of the plurality of attributes, values, of the plurality of values, that occur within a particular element or sequence in a corpus, with respect to each attribute identify rank, in a plurality of corpuses; selected and store on one or more attribute-value pairs.

7. The apparatus according to claim 6, where, when analyzing the plurality of attributes and the plurality of values, the processor is further to: use one or more elements to exclude at least one sequence from extraction.

8. The apparatus according to claim 6, where the processor is further to: process one or more set of corpuses to determine each element or sequence in the set of corpuses; associate a specific ID with each element, each respective ID indicating a part of the set of corpuses sequence; and use one or multiple of the respective IDs to determine the results metrics.

9. The apparatus according to claim 6, where the processor is further to: identifies one or more quantities in at least one corpus; and compares each of the one or more identified quantities with an ID.

10. The apparatus according to claim 6, where the processor is further to: determine a proximity between one or multiple attributes; and use the determined proximity to the identified plurality of candidate attribute-value pairs.

11. The apparatus according to claim 6, where the processor is further to: use a predefined set of values to identify one or more additional potential similar attributes and values in the corpus

12. The computer implemented method according to claims 1 and 6, the computational analysis including a classification, a categorization, comparison or a sorting of the unstructured data according to a pattern.
